(19) United States
(12) Patent Application Publication
(10) Pub. No.: US 2014/0029276 A1
(43) Pub. Date: Jan. 30, 2014

(54) MODULAR LUMINAIRE

(71) Applicant: Felipe Leon, Farmington, NY (US)

(72) Inventor: Felipe Leon, Farmington, NY (US)

(21) Appl. No.: 13/561,163

(22) Filed: Jul. 30, 2012

(51) Int. Cl. F21V 21/28; F21V 21/08

(52) U.S. Cl. CPC F21V 21/28; F21V 21/0832
USPC 362/396; 362/419

(57) ABSTRACT

A modular illumination assembly is provided such that it can be attached to a structural element. The modular illumination assembly includes an attachment member for securing the modular illumination assembly to the structural element. The modular illumination assembly also includes a first support member having a first end and a second end, such that the first end is connected to the attachment member. Further, the first support member extends from the first end in a substantially perpendicular direction to the attachment member. The modular illumination assembly also includes a second support member that is pivotably connected to the second end of the first support member, such that the second support member can rotate about the second end of the first support member. Furthermore, the modular illumination assembly includes a light source that is provided on either of a first surface or a second surface of the second support member.

### FIELD OF INVENTION

The invention disclosed herein relates, in general, to a modular illumination assembly. More specifically, the present invention relates to a modular illumination assembly that can be easily attached to a structural element.

### BACKGROUND

Organic light emitting diode (OLED) technology usually provides a highly efficient and controllable source of light that has found effective application in variety of fields including high resolution displays ranging from small screen displays for mobile telephones and the like to displays for flat screen televisions.

However, such displays are not commonly used to act as a light source to illuminate a space. Conventionally, luminaires provided for application as a light source, for example in a grid ceiling system, are typically fluorescent luminaires having fluorescent lamps, or incandescent and HID lamps.

OLEDs can be used as a substitute for these conventional light sources, as they are a promising lighting technology that combines large-area emission with a robust, flat structure adapted to illuminate a large area. OLEDs have therefore been considered as a possible light source for general lighting applications like a ceiling lighting system, but have not yet resulted in commercially viable luminaires for general lighting applications because of various challenges.

In grid ceiling applications, conventional lighting assemblies are difficult to install as they are quite bulky and inflexible and also require supporting means to ensure occupant safety. Further, installation of conventional lighting assemblies can be cumbersome and may require intensive efforts and time. Furthermore, due to mounting requirements, such lighting assemblies are not modular in nature, and as such lack flexibility in changing light beam direction, or being easily adjusted or moved as modifications in floor plans may require it.

In light of the above discussion, there is a need for an effective modular multi-purpose OLED based lighting assembly that can be used for general lighting purposes and is simple, safe, reliable, easy to install and overcomes one or more of the drawbacks listed above.

### BRIEF DESCRIPTION OF FIGURES

The features of the present invention, which are believed to be novel, are set forth with particularity in the appended claims. The invention may best be understood by reference to the following description, taken in conjunction with the accompanying drawings. These drawings and the associated description are provided to illustrate some embodiments of the invention, and not to limit the scope of the invention.

FIG. 1 is a diagrammatic illustration of a perspective view of a ceiling assembly having inverted T-section channels;

FIG. 2 is a diagrammatic illustration of a cross-sectional view of a modular illumination assembly attached to a structural element, in accordance with an exemplary embodiment of the present invention;

FIG. 3 is a diagrammatic illustration of a cross-sectional view of a modular illumination assembly, in accordance with another exemplary embodiment of the present invention;

FIG. 4 is a diagrammatic illustration of a cross-sectional view of a modular illumination assembly, in accordance with yet another exemplary embodiment of the present invention;

FIGS. 5a and 5b are diagrammatic illustrations of a side view and a top view, respectively, of a modular illumination assembly, in accordance with an exemplary embodiment of the present invention;

FIG. 6a is a diagrammatic illustration of a cross-sectional view of a modular illumination assembly including a surface adhering mechanism as an attachment member, in accordance with an exemplary embodiment of the present invention;

FIG. 6b is a diagrammatic illustration of a cross-sectional view of a modular illumination assembly including a screw structure as an attachment member, in accordance with an exemplary embodiment of the present invention; and

FIG. 6c is a diagrammatic illustration of a cross-sectional view of a modular illumination assembly including tie wires as an attachment member, in accordance with an exemplary embodiment of the present invention.

Those with ordinary skill in the art will appreciate that the elements in the figures are illustrated for simplicity and clarity and are not necessarily drawn to scale. For example, the dimensions of some of the elements in the figures may be exaggerated, relative to other elements, in order to improve the understanding of the present invention.

There may be additional structures described in the foregoing application that are not depicted on one of the described drawings. In the event such a structure is described, but not depicted in a drawing, the absence of such a drawing should not be considered as an omission of such design from the specification.

### SUMMARY

The instant exemplary embodiments of the present invention provide a modular illumination assembly that is modular in nature and can be easily attached to a variety of structural elements.

The instant exemplary embodiments of the present invention provide a modular illumination assembly that is lightweight.

The instant exemplary embodiments of the present invention provide a modular illumination assembly that enables a change in a light beam direction as required.

The instant exemplary embodiments provide a modular illumination assembly. The modular illumination assembly is such that it can be attached to a structural element. The modular illumination assembly includes an attachment member for securing the modular illumination assembly to the structural element. The modular illumination assembly also includes a first support member having a first end and a second end, such that the first end is connected to the attachment member. Further, the first support member extends from the first end in a substantially perpendicular direction to the attachment member. The modular illumination assembly also includes a second support member that is pivotably connected to the second end of the first support member, such that the second support member can rotate about the second end of the first support member. Furthermore, the modular illumination assembly includes a light source that is provided on either of a first surface or a second surface of the second support member.

The instant exemplary embodiments provide a modular illumination assembly that can be attached to a structural element. The modular illumination assembly is designed such that it includes an attachment member, a frame, a hinge and a rotatable arm connected to the frame via the hinge. Further, a light source is mounted on either one of a top or a bottom surface of the rotatable arm.

### DESCRIPTION OF THE EXEMPLARY EMBODIMENTS

Before describing the present invention in detail, it should be observed that the present invention utilizes apparatus components related to a modular illumination assembly. Accordingly the apparatus components have been represented where appropriate by conventional symbols in the drawings, showing only specific details that are pertinent for an understanding of the present invention so as not to obscure the disclosure with details that will be readily apparent to those with ordinary skill in the art having the benefit of the description herein.

While the specification concludes with the claims defining the features of the invention that are regarded as novel, it is believed that the invention will be better understood from a consideration of the following description in conjunction with the drawings, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an”, as used herein, are defined as one or more than one. The term “another”, as used herein, is defined as at least a second or more. The terms “including” and/or “having” as used herein, are defined as comprising (i.e. open transition). The term “coupled” or “operatively coupled” as used herein, is defined as connected, although not necessarily directly, and not necessarily mechanically.

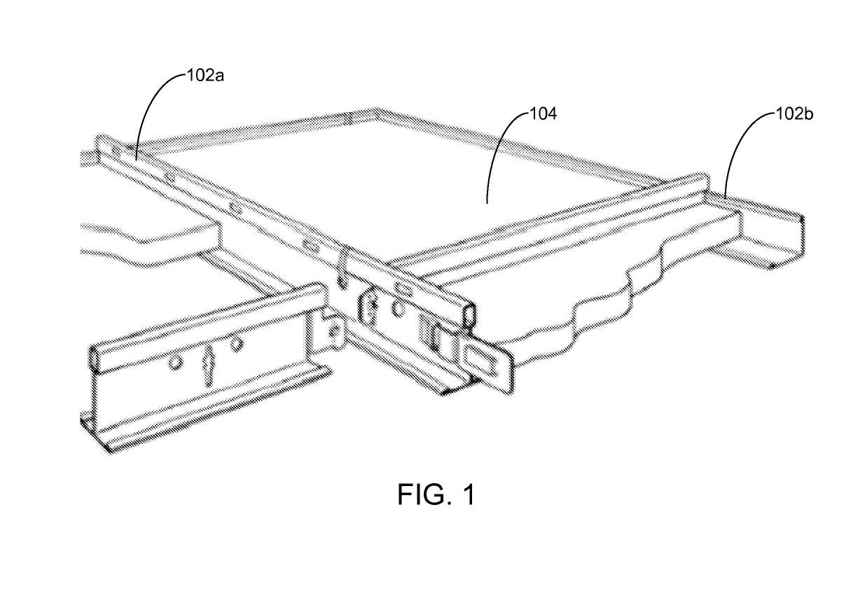

Referring now to the drawings, there is shown in FIG. 1 a structural element 102a and a structural element 102b. In real life applications, for example, the structural element 102a and the structural element 102b can be an inverted T-section channel. However, it should be appreciated that even though the figure illustrates an inverted T-section channel, the structural element 102a and 102b can also be other similar structural elements, like an L-section channel, or other types of suspended ceiling grid structures, without deviating from the scope of the invention.

Similarly, even though the figure illustrates that the T-section channel 102a and 102b are a part of a larger structure 104 like a ceiling grid 104, it should be appreciated that the larger structure 104 can be other suitable structures like drop ceilings etc., without deviating from the scope of the invention.

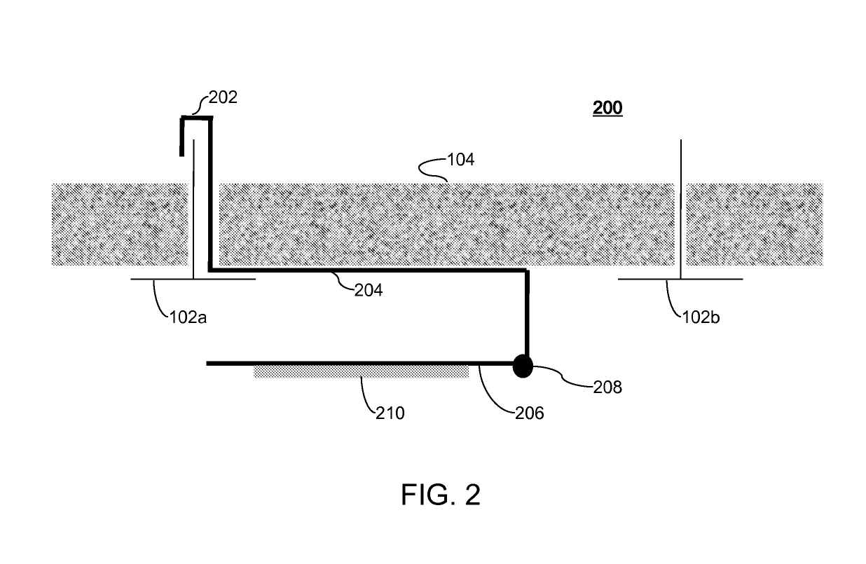

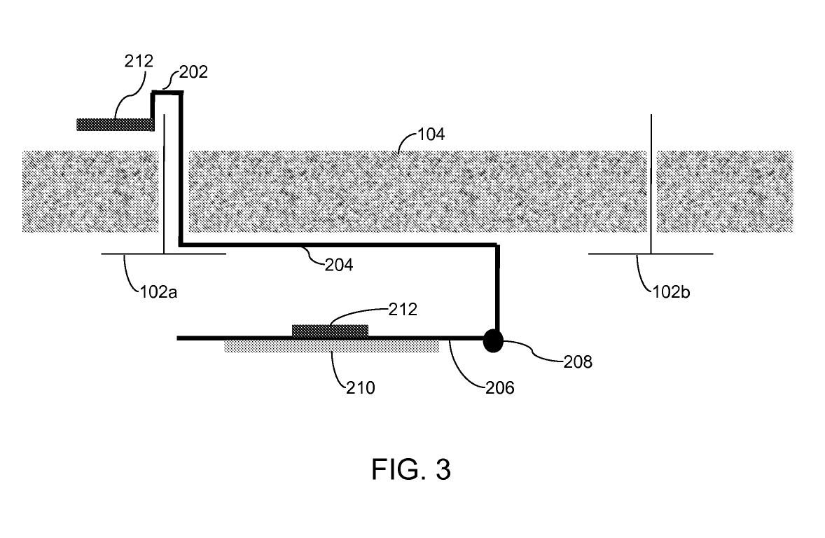

Moving on, there is shown in FIGS. 2 and 3, diagrammatic illustrations of a cross-sectional view of a modular illumination assembly 200, respectively, in accordance with two exemplary embodiment of the present invention. The modular illumination assembly 200 is shown to include an attachment member 202, a first support member 204, a second support member 206, a hinge mechanism 208, a light source 210 and one or more power supply elements 212.

For the purpose of the description, the modular illumination assembly 200 illustrated here has been shown to include only those elements that are pertinent to the description of the invention. However, it should be understood that the invention is not limited to the elements listed in the description here. In some cases, the modular illumination assembly 200 may include additional elements to enhance efficiency or to improve reliability, without deviating from the scope of the invention.

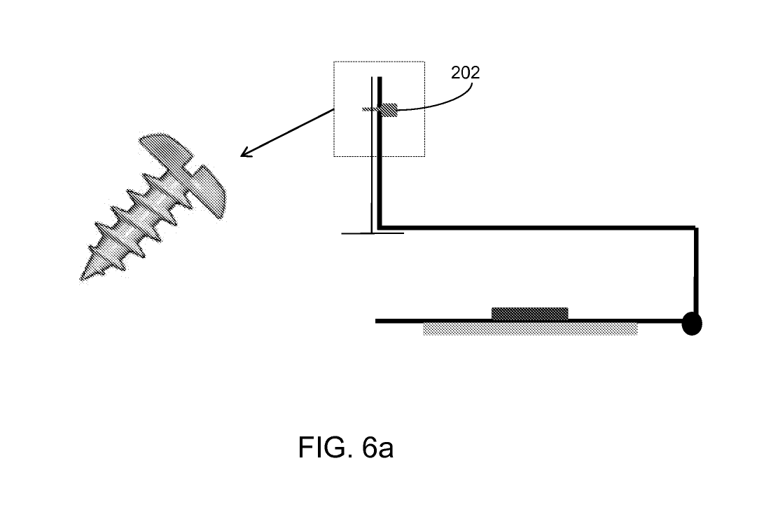

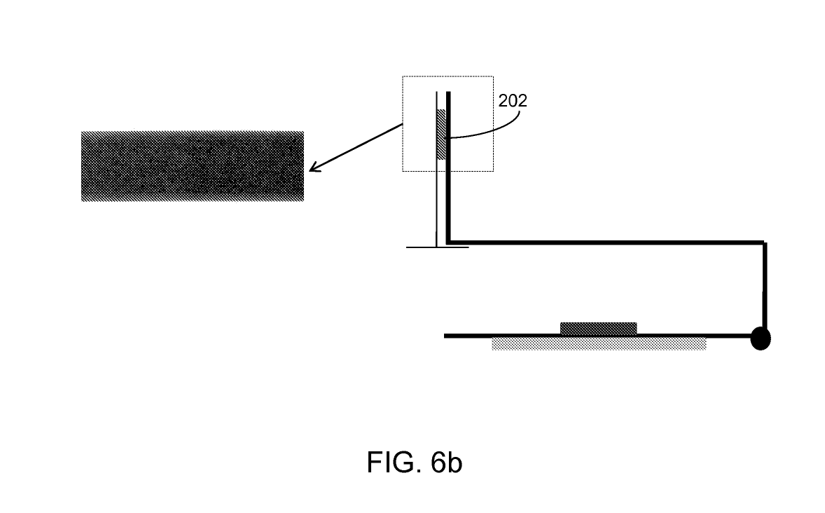

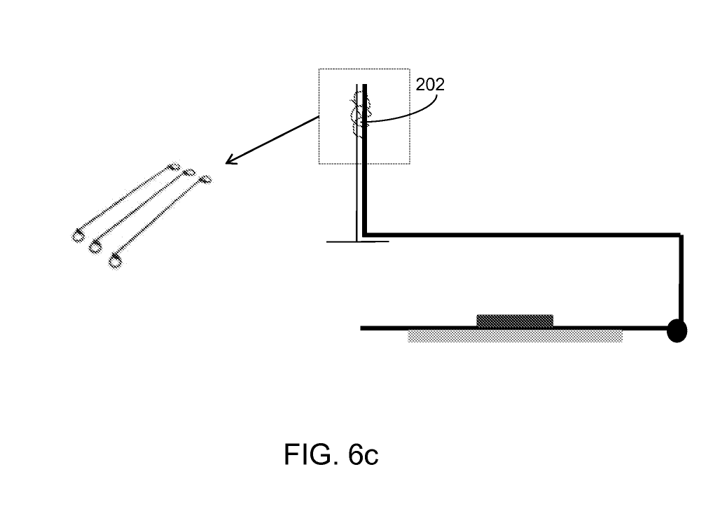

The attachment member 202 provided in the modular illumination assembly 200 enables the modular illumination assembly 200 to be securely mounted on to a structural element, like a structural element 102a or a structural element 102b. In real life applications, for example, the attachment member 202 can be in the form of a hook structure 202. The hook structure 202, for example, can enable attachment of the modular illumination assembly 200 to the structural element 102a like the inverted T-section channel 102a of the ceiling grid 104. Some examples of the attachment member 202 include, but are not limited to, a hook structure illustrated in FIGS. 2 and 3, a screw mechanism illustrated in FIG. 6a, a surface adhering mechanism illustrated in FIG. 6b and tie-wires illustrated in FIG. 6c.

Moving on, the first support member 204 provided in the modular illumination assembly 200 functions as a frame and provides strength to the modular illumination assembly 200. The first support member 204 includes a first end and a second end and is arranged such that the first end is connected to the attachment member 202. Further, the arrangement is such that the first support member 204 extends from said first end in a substantially perpendicular direction to the attachment member 202. In an embodiment, a size of the modular illumination assembly can range from 2″×2″ to about 2′×4′. However, it should be appreciated that even thought the sizes are provided with respect to a rectangular shape, the modular illumination assembly can be of any shape like square, circular, or any other shape, without deviating from the scope of the invention.

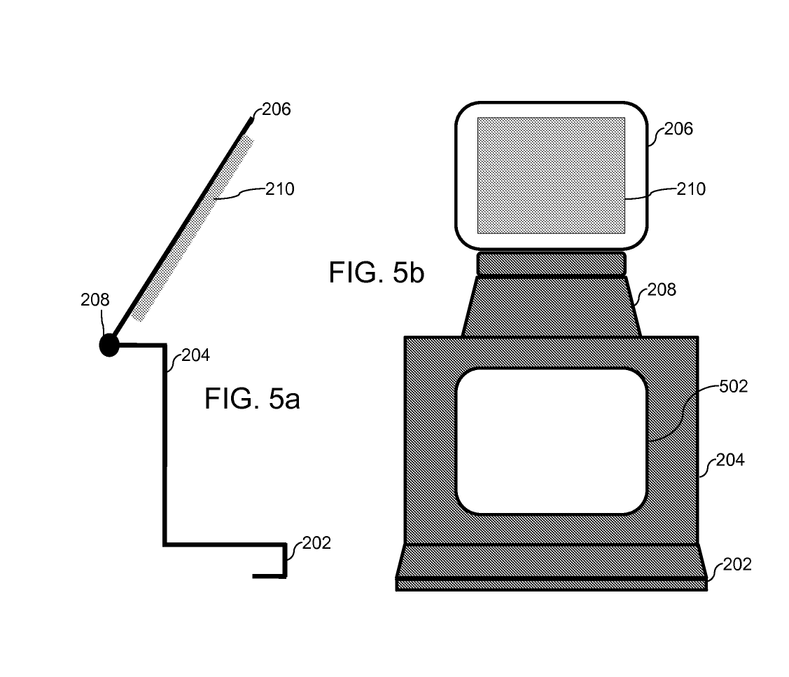

Material of the first support member 204 can be any light-weight material like aluminum, stainless steel, polished brass, acrylonitrile-butadiene styrene (ABS), wood, faux-wood etc. In real life applications, an advantage provided by the modular illumination assembly 200 is its light-weight. In addition to the material being light-weight, in some embodiments, as illustrated in FIG. 5b, a portion 502 of the first support member 204 can be cut out to from the second support member 206, to provide a further reduction of weight.

Further, it should be understood that even though for the purpose of the description, the first support member 204 has been shown to have an L-shaped structure, the first support member 204 can also have a planar structure, a rod structure, a C-shaped structure, and a disc-shaped structure, without deviating from the scope of the invention.

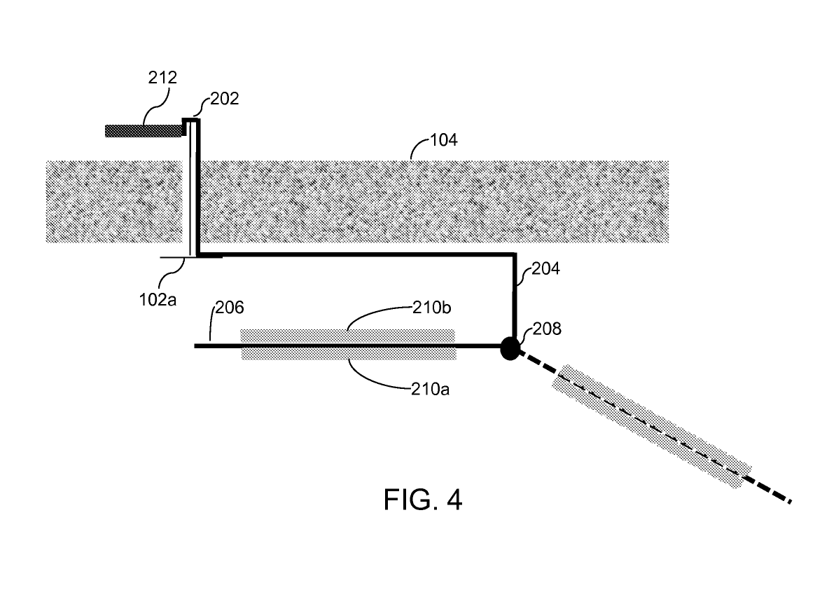

Moving on, the second support member 206 provided in the modular illumination assembly 200 functions as a member that is configured to receive the light source 210. The second support member 206 is rotatably attached to the hinge mechanism 208 at the second end of the first support member 204. The second support member 206 is provided with the ability to rotate about the hinge mechanism 208 such that it can direct the light emitted by the light source 210 in any direction as intended or required by a user. The rotation of the second support member 206 about the hinge mechanism 208, in accordance with an embodiment of the present invention, has been illustrated with the help of FIG. 4. Furthermore, in an embodiment, the modular illumination assembly 200 can also include a locking mechanism that can lock the second support member 206 with respect to the first support member 204 in a substantially user-desired position. Also, the light source 210 is positioned on the second support member 206 such that it can be prevented from crashing into the second support member 206 when fully rotated around the hinge mechanism 208.

The second support member 206 is defined by a first surface, for example a top surface and a second surface, for example a bottom surface. Further, the light source 210 is arranged such that the light source 210 can be provided on either of the top surface or the bottom surface. In some embodiments, two different light sources 210a and 210b can be provided, one each on the top surface and the bottom surface of the second support member 206. The arrangement of the two different light sources 210a and 210b, in accordance with an embodiment of the present invention, has been illustrated with the help of FIG. 4.

Material of the second support member 206 can be any light-weight material like a aluminum, stainless steel, polished brass, acrylonitrile-butadiene styrene (ABS), wood, faux-wood etc. Further, it should be understood that even though for the purpose of the description the second support member 206 has been shown to have a planar-shaped structure, the second support member 206 can also have an L-shaped structure, a rod structure, a C-shaped structure, and a disc-shaped structure, without deviating from the scope of the invention.

The light source 210 in an embodiment can be a luminaire having one or more light emitting diodes (LEDs) or organic light-emitting diodes (OLEDs) as the light source 210. The light source 210 can be in the form of a panel structure having a planar surface, with at least a portion of the panel structure including one or more OLEDs having light emitting surfaces that emit light. In an embodiment, the OLED 210 can include one or more layers of organic material sandwiched between a cathode and a transparent anode. These layers are supported on a transparent substrate, typically glass or a flexible, clear plastic like polyethylene terephthalate (PET), polyethylene naphthalate (PEN), polycarbonate (PC).

The one or more layers of the organic material are made up of an emissive layer and a conductive layer. Further, when a voltage is applied between the cathode and the anode, the cathode gives up electrons to the emissive layer and the anode draws electrons from the conductive layer, leaving positively charged “holes” in the conductive layer. The electrons in the emissive layer attract the positively charged holes towards the emissive layer, leading to combination of the electrons and the holes. This combining of the electrons and the holes leads to radiation in the form of light. Further, it is to be understood that, while a single panel type light source 210 is shown in FIGS. 2, 3, 4, 5, 6a, 6b ad 6c, two or more light sources could be provided to create different visual effects or satisfy different illumination requirements.

Some real life examples of an OLED can include, but are not limited to, White Organic Light Emitting Diode (W-OLED), Active-matrix Organic Light Emitting Diodes (AMOLED), Passive-matrix Organic Light Emitting Diodes (PMOLED), Flexible Organic Light Emitting Diodes (FOLED), Stacked Organic Light Emitting Diodes (SOLED), Tandem Organic Light Emitting Diode, Transparent Organic Light Emitting Diodes (TOLED), Top Emitting Organic Light Emitting Diode, Bottom Emitting Organic Light Emitting Diode, Fluorescence doped Organic Light Emitting Diode (F-OLED) and Phosphorescent Organic Light Emitting Diode (PHOLED).

Moving on, the light source 210 is a current controlled device, driven by one or more power supply elements 212 (illustrated in FIG. 3) connected across the anode and the cathode of the light source 210. The one or more power supply elements 212 may have an AC input and a driver that converts the AC input to a constant current for driving the light source 210. Also, in some embodiments as illustrated in FIG. 1, the power supply elements 212 if required can be situated remotely or directly on the light source 210. For example, the power supply element 212 can be mounted above a ceiling surface and be wired to the light source 210 by dropping wires down. Alternatively, the power supply element 212 can be mounted on the second surface of the second support member 206, if the light source has been mounted on the first surface of the second support member 206. Further, in yet another embodiment, the power supply element 212 can be embedded within the light source 210 itself. Further, in yet another embodiment, the power supply element 212 may be split into two separate power supply elements. A first power supply element to convert AC line voltage, such as used in homes, into a constant DC voltage to distribute to one or more modular illumination assemblies 200, and each modular illumination assembly 200 may include a second power supply element for converting a constant DC voltage into the required constant current for the modular illumination assembly 200.

In addition to the embodiments described above, the modular illumination assembly of the present invention can be used as in the form of a table lamp and a portable lighting element. Also, the module illumination assembly of the present invention may also be attached to various structures to form for example, a wall unit, an under-cabinet unit etc., without deviating from the scope of the invention.

Various embodiments, as described above, provide a modular illumination assembly that has several advantages. For example, the modular illumination assembly provided by the present invention is easy to install as they are quite light weight. Further, installation of the modular illumination assembly of the present invention has been made very easy by the presence of the attachment member that can be attached with a variety of structural elements. Furthermore, the modular illumination assembly of the present invention is modular in nature leading to a decrease in cost of manufacturing. Also, the modular illumination assembly of the present invention provides flexibility to a user to change a light beam direction as per requirement.

While the invention has been disclosed in connection with the preferred embodiments shown and described in detail, various modifications and improvements thereon will become readily apparent to those ordinarily skilled in the art. Accordingly, the spirit and scope of the present invention is not to be limited by the foregoing examples, but is to be understood in the broadest sense allowable by law.

All documents referenced herein are hereby incorporated by reference.

1. A modular illumination assembly configured to be attached to a structural element, said modular illumination assembly comprising:
a. an attachment member for securing said modular illumination assembly to said structural element;
b. a first support member having a first end and a second end, wherein said first end of said first support member is connected to said attachment member, further wherein said first support member extending from said first end is substantially perpendicular to said attachment member;
c. a second support member pivotably connected to said second end of said first support member, wherein said second support member is capable of rotating about said second end of said first support member, further wherein said second support member is defined by a first surface and a second surface; and
d. a light source mounted on at least one of said first surface of said second support member.

2. The modular illumination assembly of claim 1, wherein said structural element is one of an inverted T-section channel of a false ceiling and an L-section channel of a false ceiling and further wherein said attachment member is a hook structure capable of being structurally engaged with said structural element.

3. The modular illumination assembly of claim 1 further comprising one or more power supply elements mounted on said second surface of said second support member.

4. The modular illumination assembly of claim 1, wherein said first surface is one of a top surface and a bottom surface of said second support member.

5. The modular illumination assembly of claim 1 further comprising a locking mechanism that locks said second support member with respect to said first support member in a substantially user-desired position.

6. The modular illumination assembly of claim 1, wherein said attachment member is at least one of a hook structure, a screw mechanism, a surface adhering mechanism and tie-wires enabling engagement with said structural element.

7. The modular illumination assembly of claim 1, wherein said first support member is one of a planar structure, a rod structure, a C-shaped structure, an L-shaped structure and a disc-shaped structure.

8. The modular illumination assembly of claim 1, wherein at least one of said attachment member, said first support member and said second member is a sheet material.

9. The modular illumination assembly of claim 1, wherein said light source is an OLED luminaire.

10. The modular illumination assembly of claim 1, wherein said light source is an edge-lit LED module.

11. The modular illumination assembly of claim 1, wherein said first support member is a rectangular frame having dimensions in the order from 2″ to 4′.

12. The modular illumination assembly of claim 1, wherein said second support member is a rectangular frame having dimensions in the order from 2″ to 4′.

13. A modular illumination assembly configured to be attached to a grid ceiling, said modular illumination assembly comprising:
a. a hook structure for mounting said modular illumination assembly to a T-section channel in said grid ceiling;
b. a first support member having a first end and a second end, wherein said first end of said first support member is connected to said hook structure, further wherein said first support member extending from said first end is substantially perpendicular to said hook structure;
c. a second support member pivotably connected to said second end of said first support member, wherein said second support member is capable of rotating about said second end of said first support member, further wherein said second support member is defined by a first surface and a second surface; and
d. a light source mounted on at least one of said first surface of said second support member.

14. The modular illumination assembly of claim 11, wherein said hook structure engages with a leg portion of said T-section channel.

15. The modular illumination assembly of claim 11 further comprising one or more power supply elements mounted on said second surface of said second support member.

16. The modular illumination assembly of claim 11, wherein said first surface is one of a top surface and a bottom surface of said second support member.

17. The modular illumination assembly of claim 11 further comprising a locking mechanism that locks said second support member with respect to said first support member in a substantially user-desired position.

18. The modular illumination assembly of claim 11, wherein said attachment member is at least one of a hook structure, a screw mechanism, an surface adhering mechanism and tie-wires enabling engagement with said structural element.

19. The modular illumination assembly of claim 11, wherein said first support member is one of a planar structure, a rod structure, a C-shaped structure, an L-shaped structure and a disc-shaped structure.

20. The modular illumination assembly of claim 11, wherein said light source is an OLED luminaire.

21. The modular illumination assembly of claim 11, wherein said light source is an edge-lit LED module.

22. The modular illumination assembly of claim 11, wherein at least one of said attachment member, said first support member and said second member is a sheet material.

23. The modular illumination assembly of claim 11, wherein said first support member is a rectangular frame having dimensions in the order from 2″ to 4′.

24. The modular illumination assembly of claim 11, wherein said second support member is a rectangular frame having dimensions in the order from 2″ to 4′.
